(19) United States
(12) Patent Application Publication
(10) Pub. No.: US 2012/0311271 A1
(43) Pub. Date: Dec. 6, 2012

(54) Read Cache Device and Methods Thereof for Accelerating Access to Data in a Storage Area Network

(75) Inventors: Yaron Klein, Raanana (IL); Allon Cohen, Modiin (IL)

(73) Assignee: SANRAD, Ltd., Tel Aviv (IL)

(21) Appl. No.: 13/153,694

(22) Filed: Jun. 6, 2011

(51) Int. Cl. G06F 12/08

(52) U.S. Cl. 711/141; 711/E12.026

(57) ABSTRACT

A read cache device for accelerating execution of read commands in a storage area network (SAN) in a data path between frontend servers and a backend storage. The device includes a cache memory unit for maintaining portions of data that reside in the backend storage and mapped to at least one accelerated virtual volume; a cache management unit for maintaining data consistency between the cache memory unit and the at least one accelerated virtual volume; a descriptor memory unit for maintaining a plurality of descriptors; and a processor for receiving each command and each command response travels in the data path serving each received read command directed to the at least one accelerated virtual volume by returning requested data stored in the cache memory unit and writing data to the cache memory unit according to a caching policy.

### TECHNICAL FIELD

The present invention generally relates to caching read data in a storage area network.

### BACKGROUND OF THE INVENTION

A storage area network (SAN) connects multiple servers (hosts) to multiple storage devices and storage systems through a data network, e.g., an IP network. The SAN allows data transfers between the servers and storage devices at high peripheral channel speed.

A storage device is usually an appliance that includes a controller that communicates with the physical hard drives housed in the enclosure and exposes external addressable volumes. Those volumes are also referred to as logical units (LUs) and typically, each LU is assigned with a logical unit number (LUN).

The controller can map volumes or (LUNs) in a one-to-one mapping to the physical hard drive, such as in just bunch of disks (JBOD) or use a different mapping to expose virtual volumes such as in redundant array of independent disks (RAID). Virtual mapping as in RAID may use functionality of striping, mirroring, and may also apply parity checking for higher reliability. Storage appliances may also provide the functionality on volumes, including, for example, snapshot, backup, and the like.

Communication between the servers (also referred to as frontend servers) and storage appliances (also referred to as backend storage) is performed using a SAN communication protocol that includes hardware and software layers implementing a SCSI Transport Protocol Layer (STPL). Examples for such protocols include, for example, a Fibre Channel, internet Small Computer System Interface (iSCSI), serial attached SCSI (SAS), Fibre Channel over Ethernet (FCoE), and the like. The SAN protocol enables the frontend servers to send SCSI commands and data to the virtual volumes (LUNs) in the backend storage.

Intermediate switches (or SAN switches) can be used to connect the frontend servers to the backend storage. The system administrator can configure connectivity between frontend servers and backend storage appliances according to, for example, an access control list (ACL), or any other preferences. The SAN's configuration and topology can be set in the intermediate switches and/or in the storage appliances. In certain SAN configurations, the intermediate switches provide the functionality over the backend storage. Such functionality includes, for example, virtualization, creation of snapshots, backup, and so on.

Flash memory is a non-volatile memory that can be read or programmed a byte or a word (a NOR type memory) at a time or a page (a NAND type memory) at a time in a random access fashion. One limitation of the flash memory is that the memory must be erased a “block” at a time. Another limitation is that the flash memory has a finite number of erase-write cycles. A NAND type flash has two different types: a single level cell (SLC) and a multiple level cell (MLC). The SLC NAND flash stores one bit per cell, while the MLC NAND flash can store more than one bit per cell. The SLC NAND flash has write endurance equivalent to the NOR flash, which is typically 10 times more write-erase cycles than the write endurance of MLC NAND flash type. The NAND flash is less expensive than the NOR type flash, and erasing and writing NAND is faster than the NOR type flash.

A solid-state disk or device (SSD) is a device that uses solid-state technology to store its information and provides access to the stored information through a storage interface. A SSD device uses NAND flash memory to store the data and a controller that provides regular storage connectivity (electrically and logically) to flash memory commands (program and erase). The controller typically uses an internal DRAM memory, a battery backup, and other elements.

In contrast to magnetic hard disk drive, a flash-based storage (SSD or raw flash) is an electrical device that does not contain any moving parts (e.g., a motor). Thus, a flash-based device has much higher performances. However, due to the much higher cost of flash-based memory devices (compared to the magnetic hard disk), their limited erase counts and moderate write performance, storage appliances mainly include magnetic hard disks.

Solutions that integrate SSDs and/or flash memory units in storage systems are disclosed in the related art. One example for such a solution is the integration of a SSD in frontend servers or attaching the SSD to storage network for caching data read or written to/from the backend storage. Such implantation requires SLC based SSD which is relatively expensive. An example for such solution can be found in US Patent Application Publication No. 2011/0066808, to Flynn, et al, where it is shown a solid-state storage device that may be configured to provide caching services to the clients accessing the backing store via a storage attached network or a network attached storage. The backing store is connected to the solid-state storage device via a bus, thus the caching device is attached to the network and not operative in the network.

Another solution discussed in the related art suggests the implementation of data tiers in backend storage appliances. According to such a solution, a storage solution consists of three tiers of storage characterized by the access speed, i.e., slow disks, fast disks, and SSDs. The commonly accessed data is cached in the SSD.

The drawbacks of prior art solutions are that such solutions do not perform caching in the data path, thus data consistency of data cannot be ascertained. In addition, the caching is either at the frontend server or backend storage, thus there is no control device that overlooks the entire SAN and caches network data when needed.

Therefore, it would be advantageous to provide a data path caching solution for SANs.

### SUMMARY OF THE INVENTION

Certain embodiment disclosed herein include a read cache device for accelerating execution of read commands in a storage area network (SAN), the device is connected in the SAN in a data path between a plurality of frontend servers and a backend storage. The device comprises a cache memory unit for maintaining portions of data that reside in the backend storage and mapped to at least one accelerated virtual volume; a cache management unit for maintaining data consistency between the cache memory unit and the at least one accelerated virtual volume; a descriptor memory unit for maintaining a plurality of descriptors, wherein each descriptor indicates at least if a respective data segment of the cache memory unit holds valid data; and a processor for receiving each command sent from the plurality of frontend servers to the backend storage and each command response sent from the backend storage to the plurality of frontend servers, wherein the processor serves each received read command directed to the at least one accelerated virtual volume, wherein serving the read command includes at least returning requested data stored in the cache memory unit and writing data to the cache memory unit according to a caching policy.

Certain embodiment disclosed herein also include a method for accelerating execution of read commands in a storage area network (SAN), the method is performed by a read cache device installed in a data path between a plurality of frontend servers and a backend storage. The method includes receiving a read command, in the data path, from one of the plurality of frontend servers; checking if the read command is directed to an address space in the backend storage mapped to at least one of accelerated virtual volume; when the read command is directed to the at least one accelerated virtual volume, performing: determining how much data out of data requested to be read resides in the read cache device; constructing a response command to include entire requested data gathered from a cache memory unit of the device, when it is determined that the entire requested data resides in the device; constructing a modified read command to request only missing data from the backend storage, when it is determined that only a portion of the requested data resides in the read cache device; sending the modified read command to the backend storage; upon retrieval of the missing data from the backend storage, constructing a response command to include the retrieved missing data and the portion of data resides in the cache memory unit; and sending the response command to the one of the plurality of frontend servers initiated the read command.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention will be apparent from the following detailed description taken in conjunction with the accompanying drawings.

FIG. 1 is a schematic diagram of a SAN according to an embodiment of the invention;

FIG. 2A is a block diagram of the read cache device according to an embodiment of the invention.

FIG. 2B illustrates the arrangement of the cache management and cache memory according to an embodiment of the invention;

FIG. 3 is a flowchart illustrating execution of a write command according to an embodiment of the invention;

FIG. 4 is a flowchart illustrating execution of a read command according to an embodiment of the invention;

FIG. 5 is a flowchart illustrating the utilization of a caching policy according to an embodiment of the invention;

FIG. 6 is a schematic diagram describing one of the rule bases of the caching policy according to an embodiment of the invention; and

FIG. 7 is a schematic block diagram a tier configuration of a cache memory according to an embodiment of the invention.

### DETAILED DESCRIPTION OF THE INVENTION

The embodiments disclosed herein are only examples of the many possible advantageous uses and implementations of the innovative teachings presented herein. In general, statements made in the specification of the present application do not necessarily limit any of the various claimed inventions. Moreover, some statements may apply to some inventive features but not to others. In general, unless otherwise indicated, singular elements may be in plural and vice versa with no loss of generality. In the drawings, like numerals refer to like parts through several views.

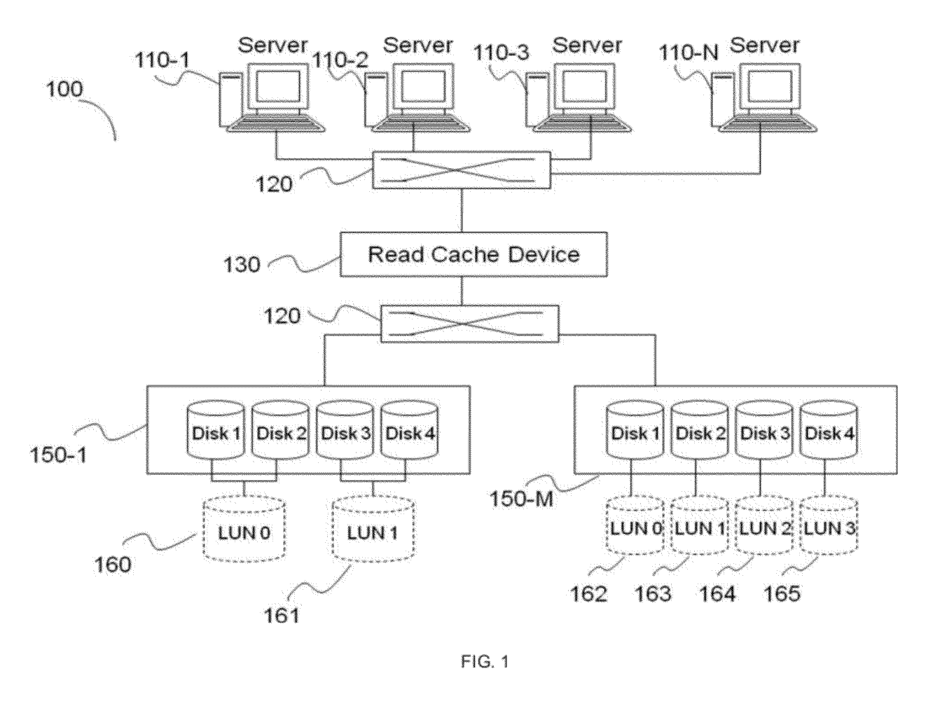

FIG. 1 shows an exemplary and non-limiting diagram of a storage area network (SAN) 100 constructed according to certain embodiments of the invention. The SAN 100 includes a plurality of servers 110-1 through 110-N (collectively referred hereinafter as frontend servers 110 connected to a switch 120. The frontend servers 110 may include, for example, web servers, database servers, workstation servers, and other types of computing devices.

In the SAN 100 there are also connected a plurality of storage appliances 150-1 though 150-M (collectively referred hereinafter as backend storage 150). The backend storage 150 may include any combination of JBOD, RAID, or sophisticated appliances as described above. The backend storage 150 can be virtualized at any level to define virtual volumes (LUs), identified by LUNs. For examples, LUNs 160 through 165 are shown in FIG. 1.

According to the teachings disclosed herein, a read cache device 130 is connected in the data path between the frontend servers 110 and the backend storage 150, through one or more switches 120. In certain embodiments, the read cache device 130 may be directly connected to the frontend servers 110 and/or backend storage 150.

The communication between frontend servers 110, read cache device 130, and backend storage 150 is achieved by means of a storage area network (SAN) protocol. The SAN protocol may be, but is not limited to, iSCSI, Fibre Channel, FCoE, SAS, and the like. It should be noted that different SAN protocols can be utilized in the SAN 100. For example, a first type of protocol can be used for the connection between the read cache device 130 and frontend servers 110, while another type of a SAN protocol can be used as a communication protocol between the backend storage 150 and the read cache device 130.

The read cache device 130 is located in the data path between the front-end servers 110 and backend storage 150 and is adapted to accelerate read operations, by temporarily maintaining portions of data stored in the backend storage 150. Residing in the data path means that all commands (e.g., SCSI commands), responses, and data blocks which travel between the frontend servers 110 to the backend storage 150, pass through the read cache device 130. This ensures that data stored in storage 150 and requested by one of the servers is fully consistent with the data stored in the cache read device 130.

According to an embodiment of the invention, the read cache device 130 is designed to accelerate the access to a set of virtual volumes consisting of one or more of the volumes 160 through 165 exposed to the frontend servers 110. These volumes will be referred hereinafter as the accelerated volumes 160. To allow this, the read cache device 130 may support any mapping of accelerated volumes to the backend storage 150.

The read cache device 130 can be configured by a user (e.g., a system administrator) to define a set of virtual volumes that will be treated as accelerated volumes 160. Only data mapped to the accelerated volumes 160 is maintained by the read cache device 130. Thus, the device 130 caches only data logically saved in the accelerated volumes 160 and handles SCSI commands addressed to these volumes. Therefore, SCSI commands, SCSI responses, and data of non-accelerated virtual volumes transparently flow from frontend servers 110 to the backend storage 150 or alternatively may bypass the read cache device 130 completely.

In an embodiment of the invention, a caching policy is configured, e.g., by a system administrator, to define priorities of the various accelerated volumes 160, a level of service to be provided by the cache, access control lists, and so on. The caching policy will be described in greater detail below.

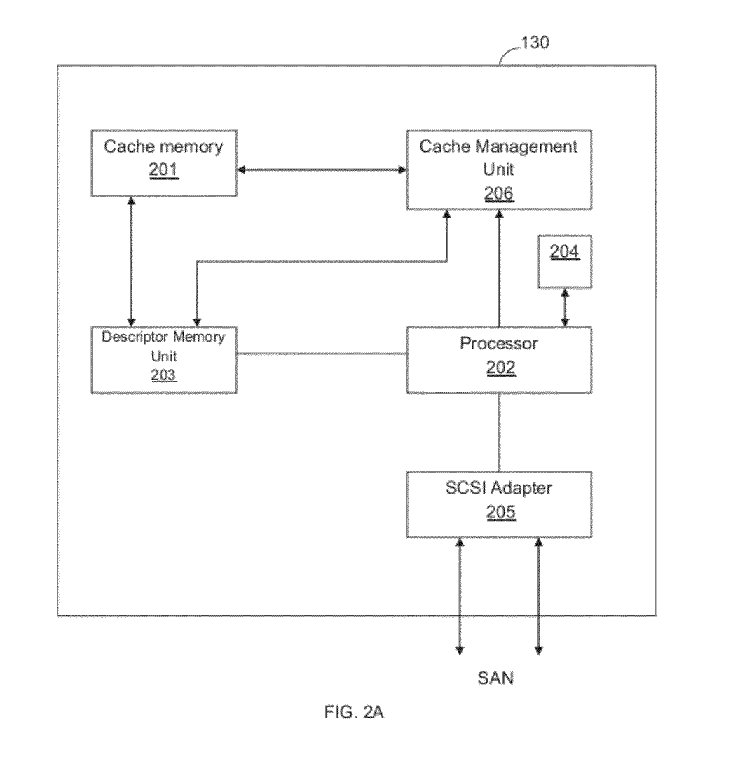

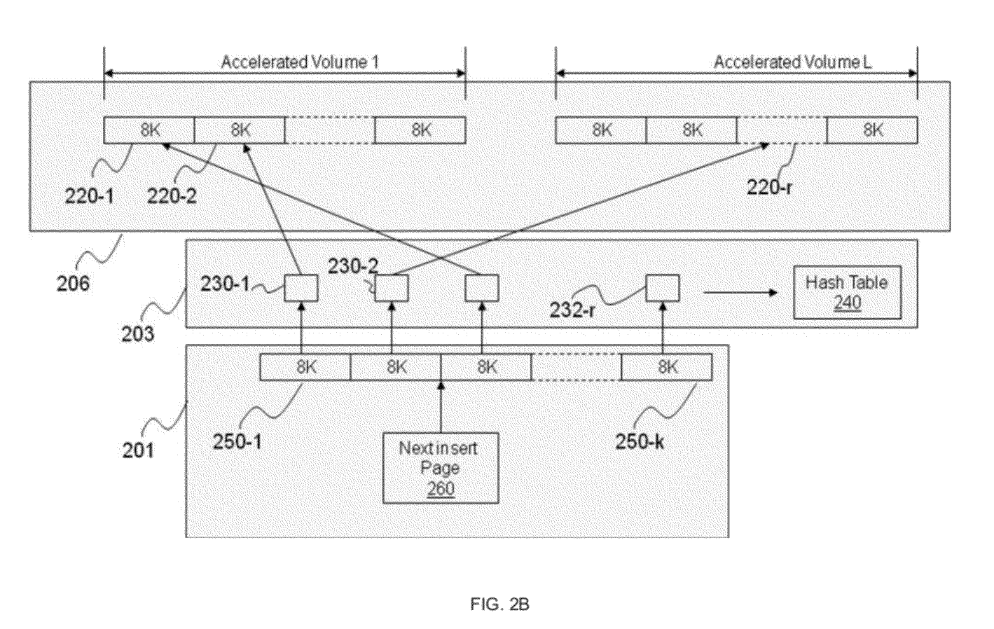

FIG. 2A shows an exemplary and non-limiting block diagram of the read cache device 130 according to an embodiment of the invention. The device 130 includes a cache memory 201, a processor 202 and its instruction memory 204, a random access memory (RAM) 203, a SCSI adapter 205, and a cache management unit 206.

The processor 202 executes tasks related to controlling the operation of the read cache device 130. The instructions for these tasks are stored in the memory 204, which may be in any form of a computer readable medium. The SCSI adapter 205 provides an interface to the frontend servers 110 and backend storage 150, through the storage area network (SAN).

The cache memory 201 may be in the form of a raw flash memory, a SSD, RAM, or combination thereof. In an embodiment of the invention, described below, the cache memory 201 may be organized in different tiers, each tier as a different type of memory. According to an exemplary embodiment, an MLC NAND type of cache is utilized. This type of flash is relatively cheaper and the number or cache-erased cycles can be monitored. The cache management unit 206 manages the data stored in the cache memory 201 and the access to the accelerated volumes 160. The arrangements of the cache memory 201, a descriptor memory unit 203, and management unit 206 are further depicted in FIG. 2B.

The cache management unit 206 is a data structure organized in aligned chunks 220, each chunk 220 has a predefined data size. The data chunks are aligned with the address space of the accelerated volumes. In an embodiment of the invention, the size of a chunk is as of a basic storage unit in the cache 201, e.g., a size of a flash memory page size. In an exemplary embodiment, the size of a chunk 220 is 8 Kilobyte (KB).

The cache memory 201 is divided into data segments 250, each of which have a same size as the chunk 220, e.g., 8 KB. The segments 250 store data from aligned addresses in the backend storage 150. As a result, the cache memory 201 can be viewed as an array of data segments. Each data segment 250 is assigned with a descriptor 230 that holds information about its respective segment 250. The descriptors 230 are stored in the descriptor memory unit 203, which may be in the form of a RAM.

The space of the accelerated volumes is logically divided to aligned segments and mapped to the aligned chucks in the management unit 206. That is, for each accelerated volume, the first segment starts at offset 0, the second at offset 0 plus a chunk's size, and so on. In the example shown in FIG. 2, the chunk's size is 8 KB and the first segment 220 of volume 1 210 starts at offset 0, the second segment 222 starts at offset 8K, and so on.

The information of descriptors 230 include, but is not limited to, a flag that indicates if the respective segment 250 holds valid information from the respective accelerated volume, the volume ID, and the logical block address (LBA) of the respective accelerated volume from which the data is taken (if any). As shown in FIG. 2B, the descriptor 230-1 of the segment 250-1 indicates valid data from data chunk 220-2 corresponding to 8 KB data unit in the accelerated volume 1. A descriptor 230-2 of another data chunk 220-r indicates no valid data.

According to an embodiment of the invention, a hash table 240 is utilized to retrieve a descriptor 230 pointing to a data chunk 220, thus to provide indication whether the respective data unit from the accelerated volume is saved in the cache memory 101. The retrieval is using the volume ID and LBA of the accelerated volume. The hash table 240 is saved in the descriptor memory unit 203.

Data is saved in the cache memory 201 in a granularity of a segment size. For example, if the segment size is 8 KB, data is written to the cache in chunks of 8 KB (e.g., 8 KB, 16 KB, 24 KB, etc.). In each insertion, the respective description 230 is updated. The data is sequentially inserted to the cache memory 201 in a cyclic order (relating to the cache memory's addresses). That is, a head index 260 maintains the last written segment place and the next segment is written to the next consecutive place. When the end of the cache is reached, the next data is written to the start of the cache memory's space.

In an embodiment of the invention, the cache memory 201 is a collection of raw flash devices. According to this embodiment, insertion of data is performed by programming the next page (one segments) or pages (several segments) in a current block. The next block is erased and set for programming, at a given time prior to when all the pages in the current block are programmed. When a block is erased, the respective descriptors 230 are updated to indicate that they no longer contain valid data.

In another embodiment, the cache memory 201 may be comprised of SSDs. According to this embodiment, inserting data segments to the cache memory 201 is performed by writing to the next 8 KB (segment's size) available in the SSDs' space. Writing multiple chunks can be performed as a write command of a big data segment. That is, writing 3 data segments (each of 8 KB) can be performed using one 24 KB write command. In another embodiment, the cache memory 201 can be comprised of a RAM memory. According to this embodiment, inserting data segment to the cache memory 201 is performed by writing to an available, e.g., 8 KB segment.

A reset operation of the read cache device 130, initializes the cache memory 101. That is, upon reset, all data chunks are marked as invalid (i.e., contain no data) and the head index is reset to the first chunk position. If the cache memory is constructed from SSDs, upon reset, a “trim” command is sent to the SSDs to indicate to the SSDs's controller to clear all internal data. If the cache memory includes raw flash devices, upon reset, all blocks may be erased to provide free space for the coming data.

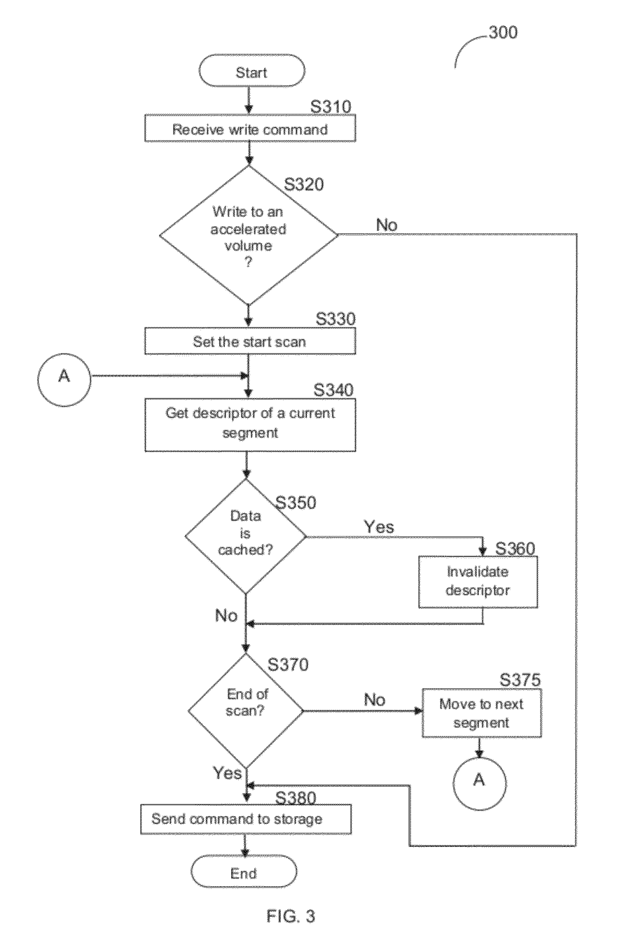

FIG. 3 shows a non-limiting and exemplary flowchart 300 illustrating the execution of a write command as performed by the read cache device 130 according to an embodiment of the invention. A write command is sent by the frontend servers 110 to the backend storage 150 through the device 130. Thus, the device 130 processes every write command, thereby maintaining consistency with the data stored at the backend storage 150, and in particular with data that is mapped to the virtual volumes. According to an embodiment of the invention, the write command is a SCSI write command.

At S310, a write command is received at the cache read device 130. The command's parameters include an address of a virtual volume to and a length of data to be written. At S320, it is checked if the command's address is of one of the accelerated volumes 160, and if so execution continues with S330; otherwise, the device 130, at S380, passes the write command to the backend storage 150 addressed by the command's address, and execution ends.

At S330 through S375, the cache memory (e.g., memory 201) is scanned to invalidate data segments stored in address range corresponding to the new data to be written. Specifically, at S330, the scan is set to start at a data segment 250 having an aligned address that is less than or equal to the command's address. At S340, a descriptor 230 respective of the current data segment is retrieved from the descriptor memory unit 203 using the hash table 240. At S350, it is checked if data is stored in the data segment in the cache memory 201, and if so, at S360, the descriptor 230 is invalidated; otherwise, at S370, another check is made to determine if the scan reaches the last data segments. The address of the last data segment is greater or equal to the address plus the length value designated in the command. If S370 results with a negative answer, execution continues to S375 where the scan proceeds to the next data segment, i.e., move to the next 8 KB (a segment's size); otherwise, at S380 the received write command is relayed to the backend storage 150.

It should be noted that if upon completion of the write command, the relevant data segments are marked as invalid, this would prevent a coherency problem between the backend storage 150 and cache memory 201 and would maintain data consistency between them. It should be further noted, that the read cache device 130 acknowledges the completion of the write command to the frontend server 110, only upon reception of an acknowledgment from backend storage 150.

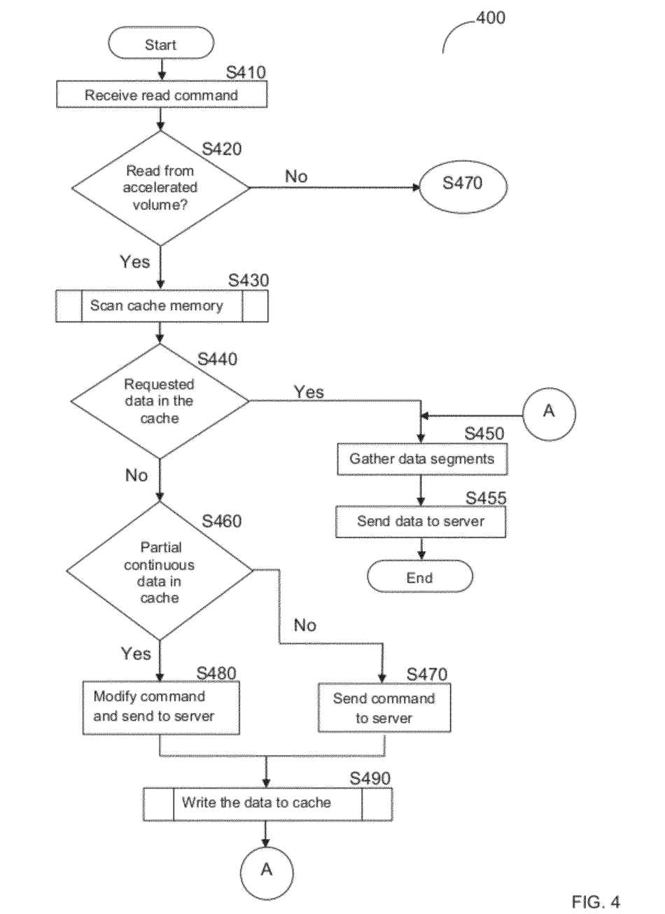

FIG. 4 shows an exemplary and non-limiting flowchart 400 illustrating the execution of a read command by the read cache device 130 according to an embodiment of the invention. As mentioned above, the device 130 is in the data path between the frontend servers 110 and the backend storage 150, thus any read command is processed by the device 130. In an embodiment of the invention, the read command is a SCSI read command.

At S410, a read command sent from a frontend server 110 is received at the cache device 130. The command's parameters include an address in the virtual volume to read the data from and a length of data to be retrieved. At S420, the device 130 checks if the received command is directed to one of the accelerated volumes 160, and if so execution continues with S430; otherwise, execution proceeds to S470 where the read command is sent to the backend storage 150.

At S430, the cache memory (e.g., memory 201) is scanned to determine if the data to be read is stored therein. The scan starts at a data segment having an aligned address less than or equal to the command's address and ends at the last segment's address that is greater or equal to the address plus the length designated in the command. Every segment 250, during the scan, is checked using the hash table 240 to determine if the respective descriptor 230 indicates that valid data is stored in the cache memory.

At S440, once the scan is completed and all the relevant segments are checked, it is determined if the entire requested data resides in the cache memory. If so, at S450, all the data segments that construct the requested read are gathered from the cache memory and sent, at S455, with successful acknowledgment to the frontend server. Thus, that read command is completely performed by the read cache device 130 without a need to issue any command to the backend storage 150, thereby accelerating the execution of read commands in the storage area network.

If S440 results with a negative answer, execution continues with S460, where it is checked if partial continuous data (requested in the command) is available in the cache memory. If no data exists in the cache memory or several segments exist in the cache in a non-continuous way relative to the backend storage, then at S470, the read command is sent to backend storage to retrieve the data. If part of the requested data exists in the cache in a continuous way, at S480, the read command is modified to request only the missing segments, and then the command is sent to the backend storage.

The read cache device 130 waits for completion of the command in the backend storage. Once the requested data is ready, at S490, a process is performed to determine if the read data should be written to the cache memory according to a caching policy. S490 is performed only if the response is received from an accelerated volume. This process is described in further detail below. Then, execution continues with S455 where the data is sent with successful acknowledgment to the frontend server 110.

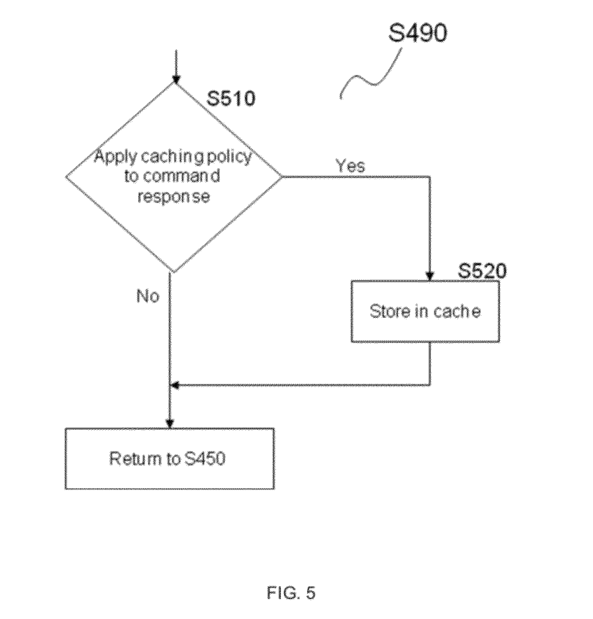

Referring to FIG. 5 where the execution of S490 is depicted. Each read command's response and data is transferred from the backend storage 150, and passes in the data path via the read cache device 130. At S510, the device 130 processes the command's response to determine if the data included therein should be saved in the cache memory (if does not already exist). The determination is based on a predefined caching policy. The policy determines if the data should be saved in the cache memory based, in part, on the following rule bases “command size”, “access pattern” and “hot area in the backend storage”, or any combination thereof. As will be described below, the caching policy may be set and dynamically updated by, for example, a system administrator or by an automatic process based on an access histogram. If S510 results with an affirmative answer, at S520, the retrieved data is saved in the cache memory; otherwise, execution returns to S450 (FIG. 4). The purpose of writing read data in the cache memory is to save on access to the backend storage in future read commands that are likely to include a request for data cached according to the caching policy.

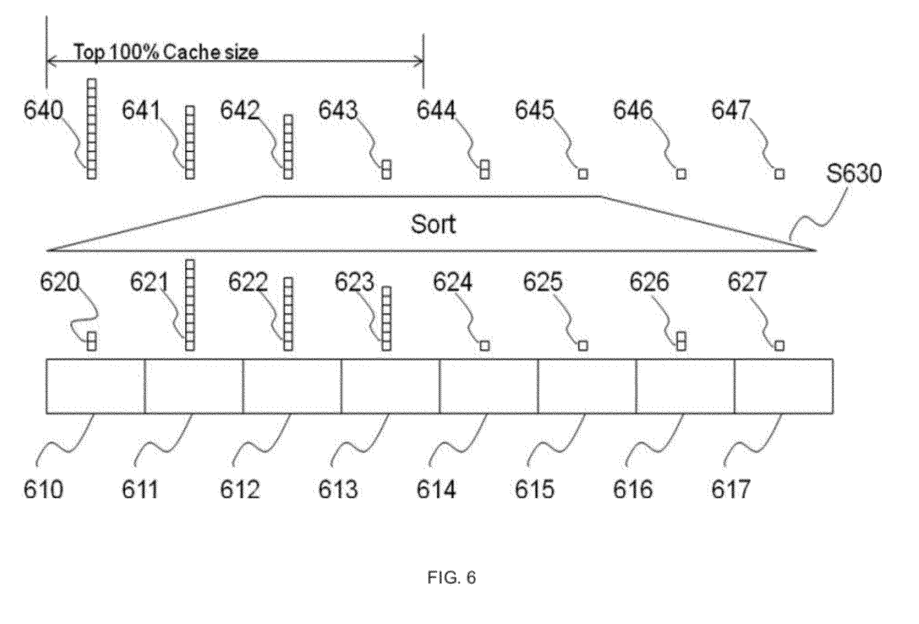

One rule base of the caching policy is “hot areas.” The hot areas in the backend storage 150 are determined based, in part, on the read (access) histogram of the backend storage 150. With this aim, the read cache device 130 gathers a read statistics to compute the histogram. This process is further illustrated in FIG. 6.

As shown in FIG. 6, the backend storage 150 is logically divided into data blocks 610, 611, 612, 613, 614, 615, 616, and 617 of fixed size (e.g., blocks of 1 GB each). Each block holds a counter that is incremented on every read command 620, 621, 622, 623, 624, 625, 626, and 627.

According to one embodiment of the invention, every fixed period of time (e.g., every minute), the counters are reduced by a fraction (e.g., by 1%) to provide least recently used counters. At predefined time intervals (e.g., every minute) the blocks' counters are sorted (operation S630) to determine the “hottest” areas in the backend storage, i.e., the blocks with the highest read counters.

According to an exemplary and non-limiting embodiment, the blocks are classified into 4 “temperature groups.” Group A includes the “hottest” (e.g., 5%) blocks of the cache's size. For example, if the cache size is 100 GB and block size is 1 GB, group A contains the “hottest” 5 blocks (regardless of the backend storage size). Group B contains the next, e.g., 10% (next 10 blocks in the above example), group C contains the next, e.g., 25% (next 25 blocks in the above example), and group D contains the next, e.g., 60% segments of the cache size (next 60 blocks). It should be appreciated that the number of temperature groups, the size of each group, and the size of each block are configurable parameters, and can be tuned, based, in part, on the backend storage size, cache memory size, and applications executed over the SAN. It should be further noted that the temperature groups' definition may be expanded or shrank per volume according to a pre-defined service level. Thus, quality of service configuration can be set to differentiate between accelerated volumes.

Another rule base of the caching policy defines whether data should be saved according to the size of the command. That is, for commands that request small size of data (i.e., small value of the length parameter), their read data will be saved in the cache memory. For example, commands for reading data greater than 16 KB are not inserted to the cache memory. In accordance with an embodiment of the invention, the rule base may be a combination of the command's address and the command's length to determine if the read data should be stored in the cache memory. A non-limiting example for such rule is provided herein:

A) If command's length (i.e., length or size of the requested data) is less than a value X (e.g., X=16 KB) and the command address is in a block from group D (defined above);
B) If command's length is less than a value Y (e.g., Y=32 KB) and the command address is in block from group C;
C) If command's length is between less than a value Z (Z=64 KB) and the command address is in a block from group B;
D) If command's length is greater than the value Z (e.g., 64 KB) and the command address is in a block from group A, then read data is stored in the cache.

In the above example, the parameters X, Y, and Z have predefined length values. According to one embodiment, the read cache device 130 is configured with a plurality of caching policies, each of which is optimized for a certain type of application For example, a policy for database applications, a policy for Virtual Desktop Infrastructure (VDI) applications, a policy for e-mail applications, and so on. The device 130 can select the policy to apply based on the application that the frontend servers 110 executes.

The policy or policies 650 can be defined by a system administrator and dynamically updated by the read cache device 130. For example, the device 130 carries out an optimization process to optimize the policy or policies based on the patterns of reads as reflected by the counters 640-647. As another example, the device 130 may dynamically optimize the policy or policies based on the current endurance count of the available cache to prolong the time the flash may be used before needing replacement.

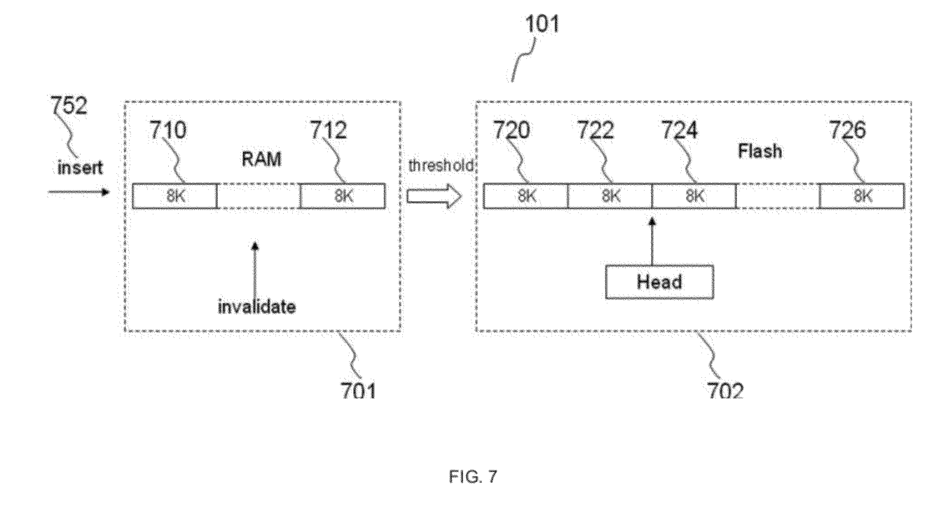

FIG. 7 shows an exemplary and non-limiting tier configuration of the cache memory 101 according to an embodiment of the invention. The cache memory 201 comprises a flash memory 702 as the main cache tier (either SSD or raw flash) and RAM memory 701 as a smaller and faster tier with negligible endurance limitation.

As shown in FIG. 7, when a RAM tier 701 is applied, every insert command (752) is inserted first to the RAM tier 701. The RAM tier 701 may be constructed with the same mechanism as described above with fixed size chunks (e.g., chunks 710 and 712).

In contrast to the flash tier 702, when a data chunk is invalidated in the RAM tier 701, the RAM tier 701 can store another chunk in the location of the invalidated chunk. That is, sequential insertion is not applied in the RAM tier 701. When the number of stored chunks in the RAM tier 701 exceeds a predefined threshold, one or more chunks are transferred to the flash memory tier 702, where the insertion of data to this tier is performed in a sequential and cyclic manner. The transfer of data between the tiers is performed in the background, i.e., when no commands are processed by the read cache device 130. The threshold assures further RAM insertion; hence enables background operation of the insertion.

The foregoing detailed description has set forth a few of the many forms that the invention can take. It is intended that the foregoing detailed description be understood as an illustration of selected forms that the invention can take and not as a limitation to the definition of the invention.

Most preferably, the various embodiments disclosed herein are implemented as any combination of hardware, firmware, and software. Moreover, the software is preferably implemented as an application program tangibly embodied on a program storage unit or computer readable medium. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

What is claimed is:

1. A read cache device for accelerating execution of read commands in a storage area network (SAN), the device is connected in the SAN in a data path between a plurality of frontend servers and a backend storage, comprising:
a cache memory unit for maintaining portions of data that reside in the backend storage and mapped to at least one accelerated virtual volume;
a cache management unit for maintaining data consistency between the cache memory unit and the at least one accelerated virtual volume;
a descriptor memory unit for maintaining a plurality of descriptors, wherein each descriptor indicates at least if a respective data segment of the cache memory unit holds valid data; and
a processor for receiving each command sent from the plurality of frontend servers to the backend storage and each command response sent from the backend storage to the plurality of frontend servers, wherein the processor serves each received read command directed to the at least one accelerated virtual volume, wherein serving the read command includes at least returning requested data stored in the cache memory unit and writing data to the cache memory unit according to a caching policy.

2. The device of claim 1, further comprises:
a SCSI adapter for interfacing with the backend storage and the plurality of frontend servers.

3. The device of claim 2, wherein the device communicates with the backend storage using a first SAN protocol and with the plurality of frontend servers using a second SAN protocol.

4. The device of claim 1, wherein each of the first SAN protocol and second SAN protocol is at least any one of: a Fibre Channel protocol, an internet Small Computer System Interface (iSCSI) protocol, a serial attached SCSI (SAS) protocol, and a Fibre Channel over Ethernet (FCoE) protocol.

5. The device of claim 1, wherein the cache memory unit is comprised of at least one of: a raw flash memory, a random access memory (RAM), and a solid-state disc (SSD).

6. The device of claim 5, wherein the cache memory unit includes tiers of memories comprising a first tier including the RAM and a second tier at least including one of the raw flash memory and the SSD, wherein data is written to the first tier and then sequential moved to the second tier when the first tier is full.

7. The device of claim 1, wherein the cache management unit is arranged in data chunks aligned with an address space of the at least one accelerated virtual volume, and the cache memory unit is arranged in data segments, wherein a size of each data segment and each data chunk is the same.

8. The device of claim 7, wherein a data segment points to a descriptor and the descriptor points to a data chunk, thereby enabling mapping between the data segment to its respective data chunk to achieve mapping between data stored in the cache memory unit and data of the at least one accelerated virtual volume.

9. The device of claim 8, wherein each of the descriptors further includes a volume identification and a logical block address (LBA) of the at least one accelerated virtual volume.

10. The device of claim 8, wherein each of the descriptors is accessed through a hash table.

11. The device of claim 1, wherein the processor is further configured to relay a received command to the backend storage when the received command is not directed to the at least one accelerated virtual volume.

12. The device of claim 8, wherein the processor serves the read command directed to the at least one accelerated virtual volume is further configured to:
determine if the entire data requested to be read is in the cache memory unit;
construct a response command to include the entire requested data gathered from the cache memory unit; and
send the command response to a frontend server initiated the read command.

13. The device of claim 12, the processor is further configured to:
determine if portions of the requested data is in the cache memory;
construct a modified read command to request only missing data from the backend storage;
send the modified read command to the backend storage;
upon retrieval of the missing data from the backend storage, construct a response command to include the data gathered from the cache memory unit and the retrieved missing data; and
send the response command to the frontend server initiated the read command.

14. The device of claim 13, the processor is further configured to:
send the received read command to the backend storage when the requested data is not in the cache memory unit; and
upon retrieval of the requested data from the backend storage, to send the requested data to the frontend server initiated the read command.

15. The method of claim 14, the processor is further configured to:
determine if the data retrieved from the backend storage should be written to the cache memory unit, wherein the determination is based on the caching policy.

16. The device of claim 15, wherein the caching policy defines a set of rules that define at least a map of hot areas in the backend storage, an access pattern to the backend storage, and a range of cacheable command's sizes, wherein if at least one of the received command and the retrieved data matches at least one of the rules, the retrieved data or portion thereof is saved in the cache memory.

17. The device of claim 16, wherein the map of hot areas is defined using an access histogram of the backend storage computed by the device, wherein computing of the access histogram includes:
logically dividing the backend storage to fixed size data blocks;
maintaining a counter to each data block;
incrementing a counter for each access to its respective data block;
decrementing the counters' values at predefined time intervals; and
classifying the data blocks according to the counters' values, wherein the data blocks with the highest count are in a hottest area.

18. The device of claim 15, wherein the caching policy is selected from a plurality of caching policies, wherein each policy is optimized to a different application executed by the plurality of frontend servers.

19. The device of claim 12, wherein the determining if the requested data is in the cache memory unit includes scanning data chunks mapped to the requested data to determine if the respective data segments in the cache memory unit hold valid data, wherein the scanning is performed using the descriptors.

20. The device of claim 8, the processor is further configured to serve a write command by:
determining if data in the write command is to be written to the at least one accelerated virtual volume;
detecting data chunks mapped to an address space designated in the write command; and
invalidating data segments in the cache memory unit that are mapped to the detected data chunks, wherein the scanning is performed using the descriptors.

21. A method for accelerating execution of read commands in a storage area network (SAN), the method is performed by a read cache device installed in a data path between a plurality of frontend servers and a backend storage, comprising:
receiving a read command, in the data path, from one of the plurality of frontend servers;
checking if the read command is directed to an address space in the backend storage mapped to at least one of accelerated virtual volume;
when the read command is directed to the at least one accelerated virtual volume, performing:
determining how much data out of data requested to be read resides in the read cache device;
constructing a response command to include entire requested data gathered from a cache memory unit of the device, when it is determined that the entire requested data resides in the device;
constructing a modified read command to request only missing data from the backend storage, when it is determined that only a portion of the requested data resides in the read cache device;
sending the modified read command to the backend storage;
upon retrieval of the missing data from the backend storage, constructing a response command to include the retrieved missing data and the portion of data resides in the cache memory unit; and
sending the response command to the one of the plurality of frontend servers initiated the read command.

22. The method of claim 21, further comprising:
sending the received read command to the backend storage when the requested data is not in the cache memory unit;
upon retrieval of the requested data from the backend storage, constructing a response command to include the retrieved data;
sending the response command to one of the frontend servers initiated the read command.

23. The method of claim 22, further comprising:
determining if portions of the data retrieved from the backend storage should be written to the cache memory unit, wherein the determination is based on a caching policy.

24. The method of claim 23, wherein the caching policy defines a set of rules that define at least a map hot areas in the backend storage, an access pattern to the backend storage, and a range of cacheable command's sizes, wherein if at least one of the received read command and the retrieved data matches at least one of the rules, the retrieved data or portion thereof is saved in the cache memory unit.

25. The method of claim 23, wherein the map of hot areas is defined by computing an access histogram of the backend storage, wherein computing of the access histogram includes:
logically dividing the backend storage to fixed size data blocks;
maintaining a counter to each data block;
incrementing a counter for each access to its respective data block;
decrementing the counters at predefined time intervals; and
classifying the data blocks according to the counters' values, wherein the data blocks with the highest count are in a hottest area.

26. The device of claim 25, wherein the caching policy is selected from a plurality of caching policies, wherein each policy is optimized to a different application executed by the frontend servers.

27. The method of claim 21, further comprising:
relaying a received command to the backend storage when the received command is not directed to the at least one accelerated virtual volume.

28. The method of claim 21, further comprising serving a write command received from one of the plurality of frontend servers by:
determining if data in the write command is to be written to the at least one accelerated virtual volume;
detecting portions of the cache memory unit mapped to an address space designated in the write command; and
invalidating such portions of the cache memory unit.

29. A non-transitory computer readable medium having stored thereon instructions for causing one or more processing units to execute the method according to claim 21.

30. A storage area network, comprising:
a plurality of frontend servers for initiating at least small computer system interface (SCSI) read commands and SCSI write commands;
a backend storage having at least one accelerated virtual volume; and
a read cache device connected in a data path between the plurality of frontend servers and the backend storage and adapted for accelerating execution of SCSI read commands by serving each read SCSI command directed to the at least one accelerated virtual volume, wherein serving the read SCSI command includes at least returning requested data stored in a cache memory unit of the read cache device and writing data to the cache memory unit of the read cache device according to a caching policy.
